(19) United States
(12) Patent Application Publication
(10) Pub. No.: US 2017/0334260 A1
(43) Pub. Date: Nov. 23, 2017

(54) ELEVATION DEVICE OF VEHICLE SHOCK ABSORBER

(71) Applicant: MAX'S INDUSTRIAL CO., LTD., Tainan City (TW)

(72) Inventor: CHAO-YI HUANG, TAINAN CITY (TW)

(21) Appl. No.: 15/591,509

(22) Filed: May 10, 2017

(30) Foreign Application Priority Data
May 18, 2016 (TW) 105207261

(51) Int. Cl. B60G 17/0165

(52) U.S. Cl. CPC B60G 17/0165; B60G 2500/30; B60G 2202/413; B60G 2204/62; B60G 2400/821

(57) ABSTRACT

The invention relates an elevating device of a vehicle shock absorber. It comprises a shock absorber having a cylinder body; and an elevating device disposed outside the cylinder body of the shock absorber and comprising a bushing having a leakproof flange at an end thereof and connected to an outer wall of the cylinder body, a lid having a chamber therein, an oil hole on a lateral wall thereof and disposed on the bushing and a hydraulic space defined by the chamber of the lid and the leakproof flange of the bushing, and the oil hole of the lid is connected to an oil tube.

### BACKGROUND OF THE INVENTION

### 1. Field of the Invention

The present invention relates to an elevation device of a vehicle shock absorber which can be mounted on a shock absorber of the vehicle for raising the vehicle chassis by hydraulic pressure.

### 2. Description of Related Art

In order to promote the stability and reduce the air resistance of vehicles, e.g. the sport cars, the modified racing cars and the like, when they are running, the height of the chassis is generally reduced. In such a case, the vehicle chassis is prone to colliding with the road that results in damage to the vehicle chassis when the vehicle climbs or passes through the bumpy road.

Accordingly, each vehicle is mounted with a shock absorber between the chassis and the wheel shaft for reducing the vibration generated by the movement of the vehicle. In addition, some shock absorbers are further provided with airbags. When a vehicle is climbing or passing through the bumpy road, the air compressor of the vehicle is driven to output high pressure gas to fill the airbag so that the filled airbag can prop up the vehicle chassis and increase the distance between the vehicle chassis and the ground. Although this method can prevent the low chassis vehicles from colliding with the road when the vehicles climb or pass the bumpy road, the method of raising the vehicle chassis by the filled airbag needs the gas pressure source to operate continuously for keeping air-filled state of the airbag. Therefore, this way not only wastes energy but also easily causes damage to the gas pressure source. Furthermore, the airbag uses the rubber as material and the vehicle chassis near the engine and the ground which generate lots of heat and ground radiant heat causing the vehicle chassis always in a high temperature state, so the rubber airbag near the high temperature chassis is prone to aging and crack. Additionally, the airbag frequently filled with high gas pressure causes the airbag to have high damage rate so that the airbag needs to be changed and repaired regularly. Accordingly, the traditional technique described above has many disadvantages, e.g. inconvenient, high cost and high traffic risk if the vehicles driven on the road and the airbag bursts suddenly.

### SUMMARY OF THE INVENTION

In view of the above-mentioned problems, the object of the present invention is to provide an elevation device of a vehicle shock absorber which can be disposed on the vehicle shock absorber for raising the vehicle chassis by hydraulic pressure.

Disclosed herein is an elevation device of a vehicle shock absorber. It comprises a shock absorber having a cylinder body and an elevating device disposed outside the cylinder body of the shock absorber, wherein the elevating device further comprises a bushing having a leakproof flange at an end thereof and connected to an outer wall of the cylinder body, a lid having a chamber therein, an oil hole on a lateral wall thereof and disposed on the bushing, and a hydraulic space defined by the chamber of the lid and the leakproof flange of the bushing, wherein the oil hole of the lid communicates with the hydraulic space.

According to an embodiment of the present invention, the lid has an open end, a closed end, a chamber for accommodating and covering the bushing, and a lid hole disposed in the center of an inner edge of the closed end and communicated with the chamber for connecting to the bushing, and wherein the hydraulic space is defined by the chamber and the closed end of the lid, and the leakproof flange of the bushing.

According to an embodiment of the present invention, the elevation device of the vehicle shock absorber further comprises a hydraulic unit having an oil tube connected to a hydraulic source at one end thereof and connected to the oil hole of the lid at the other end thereof.

According to an embodiment of the present invention, the elevating device further comprises a control unit electrically connected to the hydraulic source.

Accordingly, the oil tube of the hydraulic source connected to the oil hole on a lateral wall of the lid can drive the hydraulic source to output the hydraulic oil to the hydraulic space through the oil tube and further push the lid upwardly so that the vehicle chassis can be risen by the spring and the fixing plate mounted on the vehicle chassis and can prevent itself from colliding with the road when the vehicle is climbing and passing through the bumpy road. After the vehicle chassis rises to a predetermined height, the hydraulic source do not operate continuously in the process of pushing the vehicle chassis upwardly, so the control unit stops the hydraulic source for saving energy and avoiding damage to the hydraulic source caused by frequent action. Additionally, the bushing and the lid with high melting point and well stiffness can prevent occurrence of suddenly deforming and damaging when the vehicle is moving, so the safety of traffic can be improved.

### BRIEF DESCRIPTION OF THE DRAWINGS

FIG. 1 is a stereogram showing an elevation device of a vehicle shock absorber according to the present invention;

FIG. 2 is an exploded diagram showing an elevating device of a vehicle shock absorber according to the present invention;

FIG. 3 is a partial cross-sectional view showing an elevation device of a vehicle shock absorber according to the present invention;

FIG. 4 is a stereogram showing an elevation device of a vehicle shock absorber in use according to the present invention;

FIG. 5 is a partial cross-sectional view showing an elevation device of a vehicle shock absorber in use according to the present invention.

### DETAILED DESCRIPTION OF THE PREFERRED EMBODIMENT

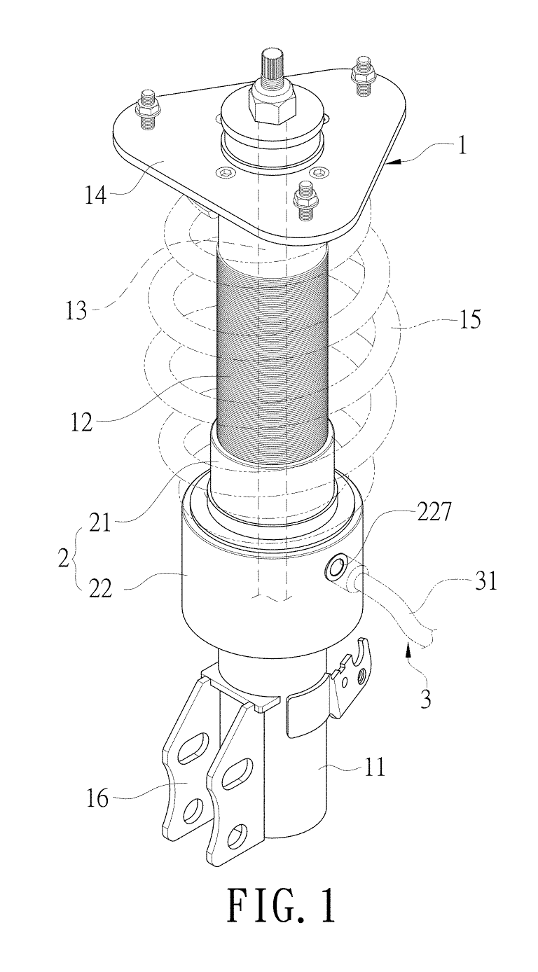

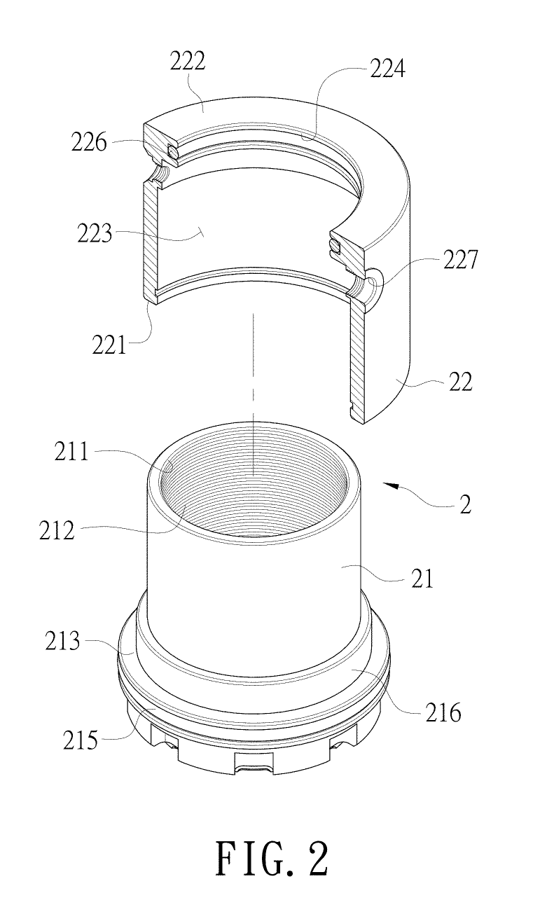

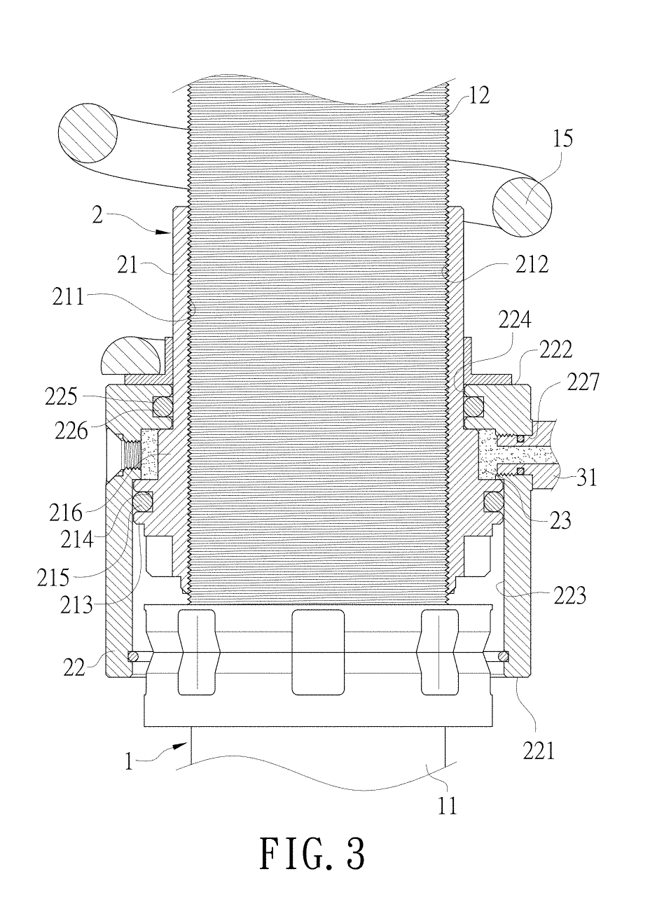

As showed in FIGS. 1-3, an elevation device of a vehicle shock absorber of the prevent invention mainly consists of a shock absorber (1), an elevating device (2) and a hydraulic unit (3).

The shock absorber (1) has a cylinder body (11), an external thread section (12) formed on an outer wall of the cylinder body (11), a piston rod (13) having an end disposed in the cylinder body (11) for moving in and out and the other end protruded from the cylinder body (11), a fixing plate (14) fixed at the other end of the piston rod (13), an elastic member (15) preferentially selected from a spring disposed outside the piston rod (13), and an assembly part (16) connected to the outer wall of the cylinder body (11).

The elevating device (2) comprises a bushing (21) and a lid (22), and both the bushing (21) and the lid (22) are made of metal material, e.g. aluminum alloy and the like. The bushing (21) further has a bushing hole (211) connected to the cylinder body (11) of the shock absorber (1), an inner thread section (212) formed on a wall of the bushing hole (211) for correspondingly threading the external thread section (12) on the cylinder body (11), a leakproof flange (213) formed near a bottom of the bushing (21), a groove (214) disposed on a peripheral wall of the leakproof flange (213), a sealing ring (215) embedded in the groove (214) for close contacting a chamber (223) of the lid (22), and a stopping flange (216) having a diameter less than that of the leakproof flange (213) and disposed on a top of the leakproof flange (213) for positioning a closed end (222) of the lid (22). The lid (22) further has an open end (221), the closed end (222), the chamber (223) for accommodating the bushing (21), a lid hole (224) disposed in the center of an inner edge of the closed end (222) for communication with the chamber (223) and connection to the bushing (21), a groove (225) disposed on a hole wall of the lid hole (224), a sealing ring (226) embedded in the groove (225) for close contacting the bushing (21), and an oil hole (227) disposed on a lateral wall of the lid (22).

Furthermore, the elevating device (2) comprises a hydraulic space (23) which is defined by a space surrounded by the chamber (223) and the closed end (222) of the lid (22), and the leakproof flange (213) of the bushing (21), so that the oil hole (227) disposed in relation to the hydraulic space (23) can communicate with the hydraulic space (23). The elastic member (15) of the shock absorber (1) has an end connected to the closed end (222) of the lid (22) and the other end connected to the fixing plate (14).

The hydraulic unit (3) comprises an oil tube (31), and the oil tube (31) has an end connected to a hydraulic source and the other end connected to the oil hole (227) of the lid (22). Furthermore, the hydraulic source further electrically connects to a control unit disposed inside the vehicle.

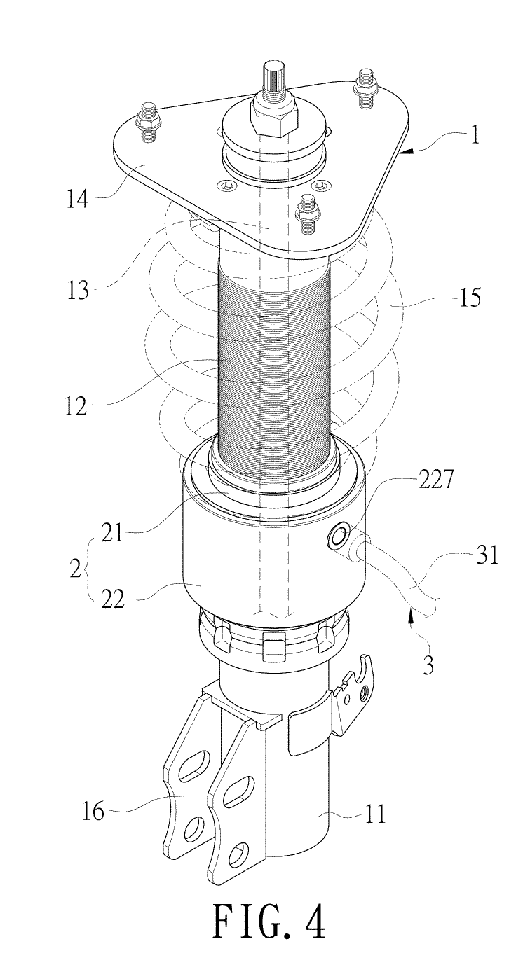

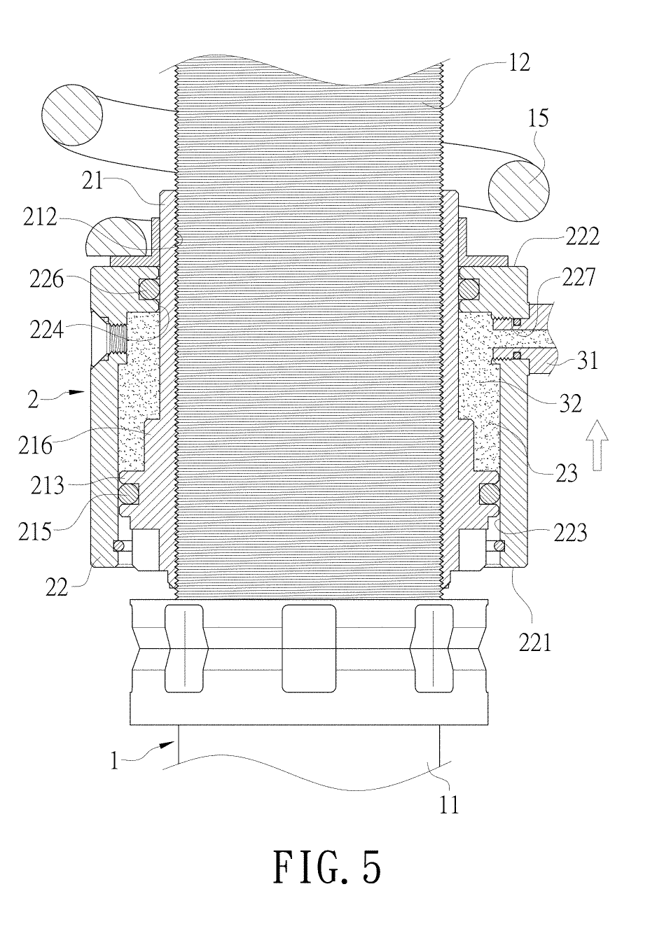

Accordingly, in use of the present invention for a vehicle with a lower chassis, e.g. the sport cars, the assembly part (16) as well as the fixing plate (14) of the shock absorber (1) and the hydraulic unit (3) are respectively fixed on the vehicle frame, on the vehicle chassis, and in the vehicle trunk. As showed in FIGS. 4, 5, when the vehicle is driven to pass through the uphill or bumpy road, the control unit can actuate the hydraulic source electrically connected thereof to make the hydraulic source output a hydraulic oil (32) to the hydraulic space (23) of the elevating device (2) through the oil tube (31). In such a case, the lid (22) of the elevating device (2) is pushed upwardly by continuous injection of the hydraulic oil (32), and the elastic member (15) connected to the closed end (222) of the lid (22) and the fixing plate (14) are also pushed upwardly with the movement of the lid (22). Thus, the piston rod (13) is extended to move the fixing plate (14) upwardly, and the vehicle chassis with the fixing plate (14) can be elevated to have an increase distance between the vehicle chassis and the ground. When the injection volume of the hydraulic oil (32) reaches the predetermined value of the control unit, the control unit automatically stop an output of the hydraulic oil (32) from the hydraulic source, and the vehicle chassis maintains the predetermined height from the ground so as to prevent itself from colliding with the road when the vehicle passes through the uphill or bumpy road.

Furthermore, the control unit can also actuate the hydraulic source to discharge the hydraulic oil (32) from the hydraulic space (23) of the elevating device (2). In such a case, the lid (22) gradually loses the propping force and drops back to the original position with the decreased volume of the hydraulic oil (32), leading the elastic member (15) and the fixing plate (14) to drop back simultaneously. Thus, the vehicle chassis with the fixing plate (14) can be lowered slowly and stably to have a decreased distance between the vehicle chassis and the ground. When the vehicle chassis returns to the original position, the control unit automatically stops the hydraulic source pumping the hydraulic oil (32) according to the programming setting in itself.

According to the above description, the present invention using hydraulic pressure to raise the vehicle chassis does not need an uninterrupted output of the hydraulic oil (32) by the hydraulic source in the process of pushing the vehicle chassis upwardly. In other words, the control unit stops operation of the hydraulic source every time the vehicle chassis is raised to a predetermined height from the ground. Therefore, the present invention can save energy and further avoid damage to the hydraulic source caused by frequent action. Additionally, the bushing (21) and the lid (22) of the elevating device (2) are made of metal material having high melting point and well stiffness, e.g. aluminum alloy and the like, so they can withstand high temperature of the vehicle chassis as well as frequent filling of hydraulic oil and prevent themselves from deformation and damage. In such a case, there is no need of frequent repair or maintenance of the present invention, which promotes the convenience and reduces the cost. Moreover, the present invention can prevent occurrence of an unexpected damage when the vehicle is moving and thus ensure the safety of traffic.

Compared with techniques available now, the present invention has the following advantages:

1. The control unit of the present invention stops operation of the hydraulic source every time the vehicle chassis is raised to a predetermined height from the ground, so the hydraulic source does not need to uninterruptedly output the hydraulic oil in the process of pushing the vehicle chassis upwardly. Thus, the present invention can save energy and further avoid damage to the hydraulic source caused by frequent action.

2. Both the bushing and the lid of the elevating device of the present invention made of metal material with high melting point and well stiffness can withstand high temperature of the vehicle chassis as well as frequent filling of hydraulic oil and prevent themselves from deformation and damage. Thus, the present invention not only has much convenience in use and low cost, but also prevent occurrence of an unexpected damage, so it can increase safety of traffic when the vehicle is moving.

What is claimed is:

1. An elevating device of a vehicle shock absorber comprise:
a shock absorber having a cylinder body; and
an elevating device disposed outside the cylinder body of the shock absorber, wherein the elevating device comprises a bushing having a leakproof flange at an end thereof and connected to an outer wall of the cylinder body, a lid having a chamber therein, an oil hole on a lateral wall thereof and disposed on the bushing, and a hydraulic space defined by the chamber of the lid and the leakproof flange of the bushing, wherein the oil hole of the lid communicates with the hydraulic space.

2. The elevating device of a vehicle shock absorber as claimed in claim 1, wherein the lid has an open end, a closed end, a chamber therein for accommodating the bushing, and a lid hole disposed in the center of an inner edge of the closed end for communication with the chamber and connection to the bushing, and wherein the hydraulic space is defined by the chamber and the closed end of the lid, and by an outer wall and the leakproof flange of the bushing.

3. The elevating device of a vehicle shock absorber as claimed in claim 1, wherein the elevating device further comprises a hydraulic unit having an oil tube connected to a hydraulic source at one end thereof and connected to the oil hole of the lid at the other end thereof.

4. The elevating device of a vehicle shock absorber as claimed in claim 3, wherein the elevating device further comprises a control unit electrically connected to the hydraulic source.
